(19) United States
(12) Patent Application Publication
(10) Pub. No.: US 2014/0035211 A1
(43) Pub. Date: Feb. 6, 2014

(54) CORROSION-RESISTANT RESILIENT MEMBER

(71) Applicants: William M. Bailey, Humble, TX (US); Paul J. Agosta, Houston, TX (US)

(72) Inventors: William M. Bailey, Humble, TX (US); Paul J. Agosta, Houston, TX (US)

(73) Assignee: BAKER HUGHES INCORPORATED, Houston, TX (US)

(21) Appl. No.: 13/563,942

(22) Filed: Aug. 1, 2012

(51) Int. Cl. F16F 1/06; B21F 35/00; F16F 1/02

(52) U.S. Cl. CPC F16F 1/06; F16F 1/024; B21F 35/00
USPC 267/166; 29/896.9

(57) ABSTRACT

A resilient member including a base material and a corrosion resistant coating disposed on the base material. The base material is cold-worked subsequent to application of the coating to the base material in order to transition the base material from having a first cross-sectional area to a second cross-sectional area. The second cross-sectional area is less than the first cross-sectional area.

### BACKGROUND

Springs and other resilient members are commonly used in the downhole drilling and completions industry, e.g., to actuate valves and other components. Alloys such as those marketed under the name Elgiloy® (an alloy of nickel, cobalt, chromium, and molybdenum) may be cold worked and heat treated to very high strengths, and in some cases are considered the only materials suitable for high-strength springs and other resilient members. While generally corrosion resistant, Elgiloy® alloys and other high strength materials may degrade and/or crack when used in highly corrosive environments, such as during or immediately after certain borehole acidizing operations. In view thereof, the industry would well receive a resilient member that has ultra high-strength properties while also being essentially chemically inert, non-reactive, and/or corrosion resistant in order to enable reliable valve actuation in even the most chemically harsh and corrosive environments.

### SUMMARY

A resilient member including a base material; and a corrosion resistant coating disposed on the base material; wherein the base material is cold-worked subsequent to application of the coating to the base material in order to transition the base material from having a first cross-sectional area to a second cross-sectional area, the second cross-sectional area less than the first cross-sectional area.

A method of making a resilient member including disposing a corrosion-resistant coating on a base material; and thereafter cold-working the base material in order to transition the base material from having a first cross-sectional area to a second cross-sectional area, the second cross-sectional area being less than the first cross-sectional area.

### BRIEF DESCRIPTION OF THE DRAWINGS

The following descriptions should not be considered limiting in any way. With reference to the accompanying drawings, like elements are numbered alike:

FIG. 1 schematically illustrates a system for making a corrosion resistant resilient member; and

FIG. 2 illustrates cross-sections of a wire at various stages during the manufacture of the resilient member by the system of FIG. 1.

### DETAILED DESCRIPTION

A detailed description of one or more embodiments of the disclosed apparatus and method are presented herein by way of exemplification and not limitation with reference to the Figures.

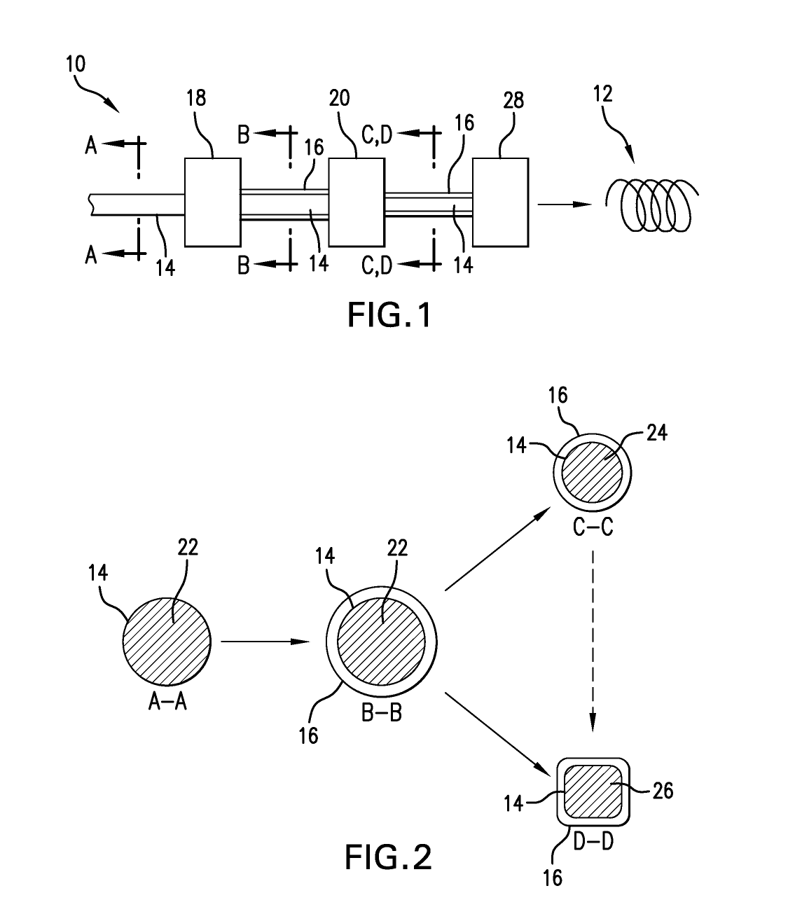

Referring now to FIG. 1, a system 10 is shown for manufacturing a resilient member 12. In the illustrated embodiment, the resilient member 12 is illustrated schematically as a coil spring, although it is to be understood that other resilient members could be made according to the current invention as disclosed herein. In the illustrated embodiment, the resilient member 12 is formed by processing a stock of a base material, generally shown and referred to as a wire 14. Of course, other types of resilient members, e.g., leaf springs, torsion springs, Belleville springs, split-rings, etc. may be utilized and initially formed from blanking, coining, stamping, cutting, or other machining operations in lieu of the wire 14, which are within the scope of the current invention as claimed and described.

The wire 14 is made from any material providing suitable characteristics for the task in which the member 12 is employed, e.g., high strength and resiliency for use as a spring. For example, alloys of cobalt, nickel, chromium, and molybdenum, such as those marketed under the trade names Elgiloy®, Conichrome®, Phynox, MP35N, etc., enable the creation of ultra high-strength springs and resilient members. Other materials, metals, alloys, etc., exhibit high strength and may also be used to manufacture springs suitable for the actuation or activation of components disposed therewith, such as downhole fluid flow control valves and other mechanisms. These nickel, cobalt, and other alloys and materials, while generally corrosion resistant, are susceptible to cracking when subjected to highly corrosive environments, such as during acidizing operations (e.g., using hydrochloric acid to treat a completion, borehole, downhole formation, etc.).

In order to protect the resilient member 12 from corrosive substances, and thereby enable the member 12 to be used in a variety of highly corrosive environments, the wire 14 is coated or plated by a coating 16 via an assembly 18. The coating 16 could be any chemically inert, non-reactive, or corrosion-resistant material such as tantalum, iridium, gold, niobium, zirconium, platinum, etc., or combinations or alloys thereof The assembly 18 is shown schematically, but one of ordinary skill in the art will readily recognize equipment appropriate for coating a high strength alloy wire with a protective material according to various chemical and/or mechanical processes. In one embodiment, the assembly 18 is a vacuum furnace assembly arranged to create the coating 16 via vapor deposition of the tantalum or other protective material onto the wire 14. In one embodiment, the assembly 18 is arranged to mechanically arrange the coating 16 on the wire 14. For example, the assembly 18 could be arranged to wind, wrap, or otherwise jacket a length of the wire 14 with the coating 16 (e.g., in the form of a strip or foil). Again, it is to be appreciated that other relatively non-reactive, chemically inert, or corrosion-resistant materials could be used and applied as the coating 16 to the wire 14 via other techniques.

After applying the coating 16, the wire 14 must be strengthened to provide functionality for the spring. Strength is gained by cold working and age hardening of the base metal of the wire 14. Particularly, the wire 14 is cold-worked by an assembly 20 to alter a cross-sectional area of the wire 14. That is, the wire 14 has an initial cross-sectional area 22 that is relatively unchanged during the process of plating the wire 14 with the coating 16. The cold-work assembly 20 is arranged to then reduce the cross-sectional area 22 by some percentage to result in a cold-worked cross-sectional area (or “cross-section”) 24 or 26. The cross-sectional area 24 may be achieved if the assembly 20 is a wire drawing assembly, e.g., in which the wire 14 is drawn through one or more dies (due to the strength of the materials used, the dies could be a carbide, diamond coated, etc.), or a stretching assembly in which the wire 14 is subjected to large tensile forces. Unlike the cross-section 24, the shape that defines the cross-sectional area 26 is also changed by the cold-working process. For example, the cross-sectional area 26 may be defined by a square, triangle, rectangle, or some other shape. In one embodiment, the assembly 20 is arranged as a “Turks Head” machine, including rollers, dies, etc., for simultaneously reshaping the wire as the cross-section is reduced. Such machines are generally known in the art and commercially available from a number of vendors.

The use of a Turks Head machine is particularly useful in the above-noted embodiment in which the coating 16 is mechanically applied (e.g., wrapped or wound in the form of a strip or foil) to the wire 14. Namely, this is because the coating 16 runs the risk of being mechanically stripped off the wire 14 when subjected to conventional drawing techniques (especially for relatively softer materials such as tantalum). In other embodiments in which the coating 16 is mechanically applied to the wire 14, a secondary coating material (e.g., a material having a hardness greater than that of the coating 16 and circumferentially covering or jacketing the coating 16) could be temporarily added (e.g., via any suitable chemical or mechanical process, such as those discussed herein) to protect the coating 16 during a drawing process, then chemically etched or mechanically removed after drawing. That is, any damage that would have otherwise occurred to the coating 16 while drawing through one or more dies would be imparted instead on the secondary coating, which is not relied upon for any of the properties of the final member 12.

As represented by the dashed arrow between the cross-section 24 and the cross-section 26, the assembly 20 could be arranged to first reduce a wire having an initial shape (e.g., circular) in cross-sectional area (e.g., from the cross-section 22 to the cross-section 24) by a drawing, stretching, or other operation and then to reshape the wire to a second shape (e.g., rectangular, as represented by the transition from the cross-section 24 to the cross-section 26). Other polygonal shapes could be used or may result from further processes, e.g., in one embodiment a rectangular cross-section may take on a more trapezoidal shape when the wire 14 is wound into a coil spring. In other words, the assembly 20 could take the form of any suitable machine including dies, rollers, mandrels, presses, rams, etc., for drawing, stretching, hammering, bending, reshaping, etc. Of course, one of ordinary skill in the art would appreciate a myriad of assemblies capable of cold-working a wire in order to alter its cross-section as discussed above.

With respect to the specific embodiment in which the wire 14 is formed from Elgiloy® alloy and the coating 16 from tantalum, the current inventors have discovered that after applying the tantalum by a vapor deposition process, the cross-sectional area of the wire 14 can be reduced to about 30% to 60% of its initial value without the risk of the tantalum being damaged or stripped off of the wire. Advantageously, cold-working the wire 14 to this degree strengthens the wire 14 to suitable levels for enabling the resilient member 12 to be used for its ultimate purpose, e.g., in downhole actuation applications subjected to a highly corrosive or acidized environment.

Lastly, the wire 14, with the coating 16, is formed into a final part, e.g., a coil spring, by a shaping assembly 28. For other resilient members, the shaping operation may occur prior to the coating and cold-working (e.g. blanking out a part to be used as a leaf spring before applying a coating to the part and cold-working the part). Such machines are well known in the art and thus do not require an extended description for the purposes of describing the current invention. That is, the shaping assembly 28 could be any type of machine known in the art for forming a resilient member from the wire 14, of which many will be readily known or available to one of ordinary skill in the art. In one embodiment, the assembly 28 is a winding machine that shapes or spirals the wire 14 about a mandrel into a coil and then cuts the coiled wire to length to form the resilient member 12.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A resilient member comprising:
a base material; and
a corrosion resistant coating disposed on the base material;
wherein the base material is cold-worked subsequent to application of the coating to the base material in order to transition the base material from having a first cross-sectional area to a second cross-sectional area, the second cross-sectional area less than the first cross-sectional area.

2. The resilient member of claim 1, wherein the first cross-sectional area is reduced about 30% to 55% to yield the second cross-sectional area.

3. The resilient member of claim 1, wherein the first cross-sectional area is defined by a first shape and the second cross-sectional area is defined by a second shape.

4. The resilient member of claim 3, wherein the first shape is circular and the second shape is polygonal.

5. The resilient member of claim 1, wherein the base material includes nickel, cobalt, chromium, molybdenum, or a combination including at least one of the foregoing.

6. The resilient member of claim 5, wherein the base material is an alloy including each of nickel, cobalt, chromium, and molybdenum.

7. The resilient member of claim 1, wherein the coating is tantalum, gold, iridium, niobium, zirconium, platinum, or a combination including at least one of the foregoing.

8. The resilient member of claim 1, wherein the resilient member is formed as a coil spring.

9. The resilient member of claim 1, wherein the corrosion-resistant coating is applied to the base material via a vapor deposition process.

10. The resilient member of claim 1, wherein the corrosion-resistant coating is applied to the base material via a mechanical winding, wrapping, or jacketing process.

11. A method of making a resilient member comprising:
disposing a corrosion-resistant coating on a base material; and
thereafter cold-working the base material in order to transition the base material from having a first cross-sectional area to a second cross-sectional area, the second cross-sectional area being less than the first cross-sectional area.

12. The method of claim 11, wherein the cold-working includes reducing the first cross-sectional area by about 30% to 55% to yield the second cross-sectional area.

13. The method of claim 11, wherein the base material is formed as a wire.

14. The method of claim 13, wherein the cold-working includes drawing the wire, stretching the wire, reshaping the wire, coiling the wire, or a combination including at least one of the foregoing.

15. The method of claim 11, wherein disposing the corrosion-resistant coating includes a vapor deposition process.

16. The method of claim 11, wherein disposing the corrosion-resistant coating includes a mechanical winding, wrapping, or jacketing process.

17. The method of claim 11, wherein the base material includes nickel, cobalt, chromium, molybdenum, or a combination including at least one of the foregoing.

18. The method of claim 11, wherein the first cross-sectional area is defined by a first shape and the second cross-sectional area is defined by a second shape and the cold-working includes reshaping the base material between the first and second shapes.

19. The method of claim 11, wherein the coating is tantalum, gold, iridium, platinum, niobium, zirconium, or a combination including at least one of the foregoing.
